(19) United States
(12) Patent Application Publication
(10) Pub. No.: US 2014/0002301 A1
(43) Pub. Date: Jan. 2, 2014

(54) APPARATUS AND METHOD FOR PROVIDING LOCATION INFORMATION AND ADDITIONAL INFORMATION USING PSEUDOLITE NAVIGATION SYSTEM

(71) Applicants: Man-Ho PARK, Daejeon (KR); Han-Chul KIM, Daegu (KR)

(72) Inventors: Man-Ho PARK, Daejeon (KR); Han-Chul KIM, Daegu (KR)

(73) Assignee: Electronics and Telecommunications Research Institute, Daejeon (KR)

(21) Appl. No.: 13/616,616

(22) Filed: Sep. 14, 2012

(30) Foreign Application Priority Data
Jun. 27, 2012 (KR) 10-2012-0069365

(51) Int. Cl. G01S 19/48

(52) U.S. Cl. 342/357.31

(57) ABSTRACT

A global positioning system (GPS) transmitter includes: an interface unit configured to receive user additional information from an additional information providing device; a location information providing unit configured to manage preset location information or location information set by a user; and a transmitting unit configured to generate a GPS-tag frame by combining the user additional information and the location information from the location information providing unit based on a plurality of pseudo random noise (PRN) codes, and transmit the generated GPS-tag frame to a service area.

### CROSS-REFERENCE(S) TO RELATED APPLICATIONS

This application claims priority to Korean Patent Application No(s). 10-2012-0069365, filed on Jun. 27, 2012, which is incorporated herein by reference in its entirety.

### BACKGROUND OF THE INVENTION

1. Field of the Invention

Exemplary embodiments of the present invention relate to an apparatus and method for providing location information and additional information using a pseudolite navigation system; and, particularly, to an apparatus and method for providing location information and additional information using a pseudolite navigation system, which provides location information and additional user-defined information to a user belonging to a service area of the pseudolite navigation system.

2. Description of Related Art

In general, a global positioning system (GPS) is used to provide location information to a user. That is, a receiver having a GPS function receives a GPS signal transmitted from a GPS satellite orbiting the earth. The receiver demodulates the received GPS signal to measure a distance between the GPS satellite and the receiver. At this time, when no obstacles exist between the receiver and the GPS satellite, the receiver may normally receive the signal transmitted from the GPS satellite to perform a positioning operation.

However, when an obstacle exists between the receiver and the GPS satellite (for example, the receiver is located indoors or located between buildings in a downtown area, where a straight transmission path between the GSP satellite and the receiver is difficult to secure), the receiver may have difficulties in receiving the GPS signal transmitted from the GPS satellite. In this case, the precision of the positioning operation may be reduced, or the receiver may not receive a GPS signal so as not to perform the positioning operation.

In order to solve such a problem, an indoor navigation system using a pseudolite (that is, a pseudolite navigation system) has been recently developed and used. For example, Korean Patent Laid-open Publication No. 10-2003-0038449 discloses a pseudolite-based precise navigation system with synchronized pseudolites, which includes a plurality of pseudolites capable of transmitting the same GPS signal as a GPS satellite and installed in designated indoor positions, and performs the same positioning process as a system using the GPS satellite through the plurality of pseudolites. According to the navigation system, it is possible to utilize location information using a GPS receiver indoors.

However, the conventional pseudolite-based navigation system requires a process of arranging a plurality of pseudolite signal transmitters according to settings which are precisely configured to support a positioning process based on existing methods. Furthermore, the conventional pseudolite-based navigation system requires a process of performing signal synchronization for each transmission period. Therefore, an expensive receiver must be used.

Furthermore, since the conventional pseudolite system operates the plurality of pseudolite signal transmitters indoors, various problems such as wave reflection may occur, thereby degrading the positioning performance.

### SUMMARY OF THE INVENTION

An embodiment of the present invention is directed to an apparatus and method for providing location information and additional information using a pseudolite navigation system, which provides a message obtained by combining additional information and location information to a user, thereby providing an additional service while efficiently providing location information.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a GPS transmitter includes: an interface unit configured to receive user additional information from an additional information providing device; a location information providing unit configured to manage preset location information or location information set by a user; and a transmitting unit configured to generate a GPS-tag frame by combining the user additional information and the location information from the location information providing unit based on a plurality of pseudo random noise (PRN) codes, and transmit the generated GPS-tag frame to a service area.

The transmitting unit may generate the GPS-tag frame having a plurality of slots matched with the respective PRN codes, and each of the slots may include a slot header and a slot message.

The slot header may include an index field for setting a GPS-tag solution and recording the index of an additional information table, in order to transmit the user additional information.

The index field may be broken down into two areas, a message arranged in the front portion of user information may be set in the first area, and a message arranged in the rear portion of the user information may be set in the second area.

The slot header may include a slot field for recording slot information forming the GPS-tag frame, and the information transfer period may be set based on the number of slots included in the slot information.

The slot header may include a location information field for recording whether location information is provided or not.

When the location information field indicates that the location information is provided, the location information may be recorded in the final slot among the plurality of slots.

The slot header may include a message type field for recording the type of data recorded in the slot message.

The slot message may include link information corresponding to a reception path of additional information.

The slot header may include a cyclic redundancy check (CRC) field to record an error correction code for expressing an expression sequence between abbreviated user information provided through the slot header and message information provided through a slot message, and detecting and correcting an error.

In accordance with another embodiment of the present invention, a method for providing location information and additional information using a pseudolite navigation system includes: receiving user additional information from an additional information providing device by a GPS transmitter; detecting preset location information by the GPS transmitter; generating a GPS-tag frame by combining the user additional information and the detected location information based on a plurality of PRN codes by the GPS transmitter; and transmitting the generated GPS-tag frame to a service area by the GPS transmitter.

In generating the GPS-tag frame, the GPS transmitter may generate the GPS-tag frame having a plurality of slots matched with the respective PRN codes, and each of the slots may include a slot header and a slot message.

In generating the GPS-tag frame, the GPS transmitter may generate the GPS-tag frame including a slot header having an index field for setting a GPS-tag solution and recording an index of an additional information table, in order to transmit the user additional information.

In generating the GPS-tag frame, the index field may be classified into two areas, a message arranged in the front portion of user information may be set in the first area, and a message arranged in the rear portion of the user information may be set in the second area.

In generating the GPS-tag frame, the GPS transmitter may generate a GPS-tag frame including a slot header having a slot field for recording slot information forming the GPS-tag frame, and an information transfer period may be set based on the number of slots included in the slot information.

In generating the GPS-tag frame, the GPS transmitter may generate the GSP-tag frame including a slot header having a location information field for recording whether the location information is provided or not.

In generating the GPS-tag frame, when the location information field indicates that the location information is provided, the location information may be recorded in the final slot among the plurality of slots.

In generating the GPS-tag frame, the GPS transmitter may generate the GPS-tag frame including a slot header having a message type field for recording the type of data recorded in the slot message.

In generating the GPS-tag frame, the GPS transmitter may generate the GPS-tag frame including a slot message having link information corresponding to a reception path of additional information.

In generating the GPS-tag frame, the GPS transmitter may generate the GPS-tag frame including a slot header having a CRC field to record an error correction code for expressing an expression sequence between abbreviated user information provided through the slot header and message information provided through a slot message, and detecting and correcting an error.

### BRIEF DESCRIPTION OF THE DRAWINGS

FIG. 1 is a diagram for explaining an apparatus for providing location information and additional information using a pseudolite navigation system in accordance with the embodiment of the present invention.

FIG. 2 is a diagram for explaining a GPS transmitter of FIG. 1.

FIG. 3 is a diagram for explaining a GPS receiver of FIG. 1.

FIG. 4 is a flow chart showing a signal transmission method of a method for providing location information and additional information using a pseudolite navigation system in accordance with the embodiment of the present invention.

FIG. 5 is a flow chart showing the transmitted signal processing method of the method for providing location information and additional information using a pseudolite navigation system in accordance with the embodiment of the present invention.

FIG. 6 is a diagram for explaining a data structure of a GPS-tag frame used in the apparatus and method for providing location information and additional information using a pseudolite navigation system in accordance with the embodiment of the present invention.

FIG. 7 is a diagram for explaining an example of the GPS-tag frame used in the apparatus and method for providing location information and additional information using a pseudolite navigation system in accordance with the embodiment of the present invention.

FIG. 8 is a diagram for explaining the structure of a slot head of FIG. 6.

FIG. 9 is a diagram for explaining a use example of the index field of FIG. 8.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

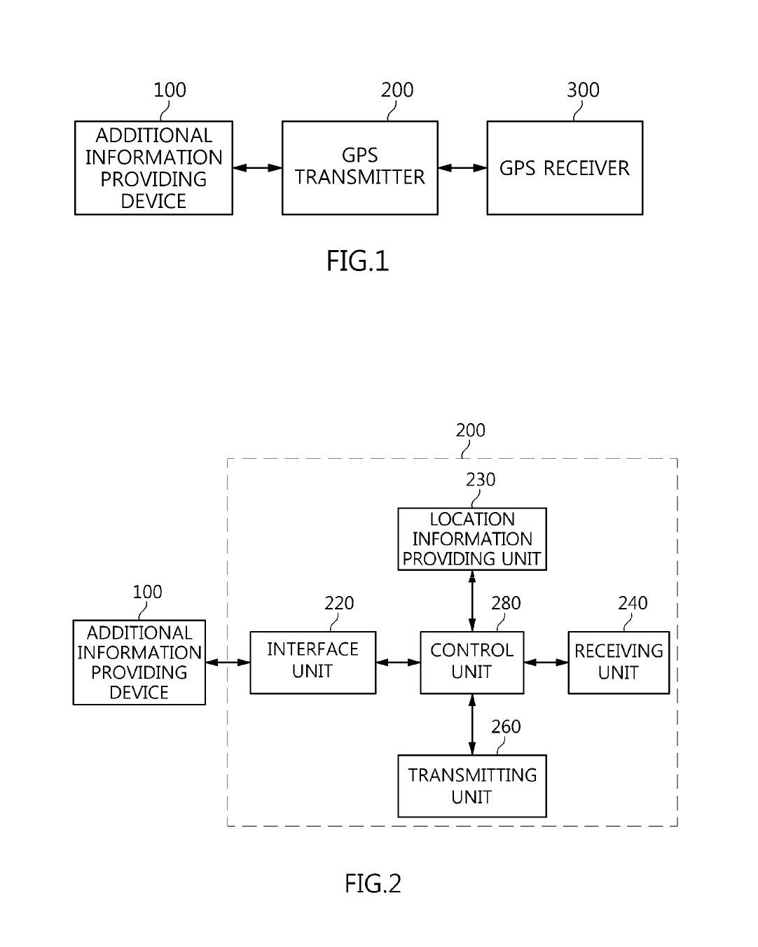

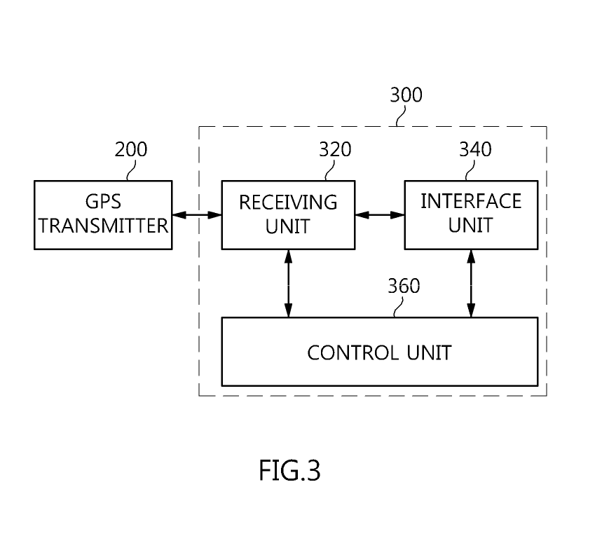

Hereafter, an apparatus and method for providing location information and additional information using a pseudolite navigation system in accordance with an embodiment of the present invention will be described in detail with reference to the accompanying drawings. FIG. 1 is a diagram for explaining an apparatus for providing location information and additional information using a pseudolite navigation system in accordance with the embodiment of the present invention. FIG. 2 is a diagram for explaining a GPS transmitter of FIG. 1. FIG. 3 is a diagram for explaining a GPS receiver of FIG. 1.

Referring to FIG. 1, the apparatus for providing location information and additional information using a pseudolite navigation system includes an additional information providing device 100, a GPS transmitter 200, and a GPS receiver 300. Here, the GPS transmitter 200 indicates a GPS-tag transmitter to transmit a GPS-tag frame in accordance with the embodiment of the present invention, and the GPS receiver 300 indicates a GPS-tag receiver to receive a GPS-tag frame in accordance with the embodiment of the present invention.

The additional information providing device 100 performs a GPS-tag control function for a service provider, which is related to a process of providing location information and additional information using the pseudolite navigation system, and an interface function for the service provider. That is, the additional information providing device 100 performs the GPS-tag control function to set a GPS-tag ID, information transmitted to a user by the service provider, and link information. Furthermore, the additional information providing device 100 performs the interface function to output information on the state of the GPS-tag, information on whether the operation is normally performed or not, and output information of the GPS-tag such that the service provider may check the respective pieces of information. Here, the additional information providing device 100 is provided separately from the GPS transmitter 200, but may be configured as a module built in the GPS transmitter 200.

The GPS transmitter 200 generates a GPS-tag frame using location information and the user additional information provided from the additional information providing device 100. The GPS transmitter 200 transmits the generated GPS-tag frame to a GPS receiver 300 located in a specific area. The GPS transmitter 200 monitors the GPS-tag frame and checks the state of the GPS-tag frame. For this operation, referring to FIG. 2, the GPS transmitter 200 includes an interface unit 220, a location information providing unit 230, a receiving unit 240, a transmitting unit 260, and a control unit 280.

The interface unit 220 is configured to provide an interface for exchanging control signals and information between the additional information providing device 100 and the control unit 280. That is, the interface unit 220 transmits a user additional information request signal from the control unit 280 to the additional information providing device 100. The interface unit 220 receives user additional information based on the user additional request signal from the additional information providing device 100. The interface unit 220 provides the received user additional information to the control unit 280.

The position information providing unit 230 is configured to provide location information to the control unit 280. At this time, the location information providing unit 230 manages preset location information or location information set by a user in an indoor space such as a house or office, where a GPS satellite signal cannot be received. The location information providing unit 230 provides the managed location information to the control unit 280. At this time, depending on a user's setting, the receiving unit 240 to be described below may provide location information to the control unit 280 in an indoor space where a GPS satellite signal may be received, instead of the location providing unit 230.

The receiving unit 240 is configured to receive a signal transmitted from the transmitting unit 260. The receiving unit 240 determines whether the received signal is normal or not.

The transmitting unit 260 is configured to combine the user additional information and the location information and generate a GPS-tag frame. That is, the transmitting unit 260 generates the GPS-tag frame by combining the user additional information and the location information which are received with a transmit signal request signal from the control unit 280. At this time, the transmitting unit 260 is a function block to generate basic transmission data of a GPS-tag (that is, GPS-tag frame), and generates the GPS-tag frame by combining user additional information processed in parallel using a plurality of pseudo random noise (PRN) signals. The transmitting unit 260 generates the GPS-tag frame through parallel processing based on the channel configuration (PRN number) set by the additional information providing device 100. Here, the GPS-tag frame is generated as a baseband signal.

The transmitting unit 260 is configured to transmit the generated GPS-tag frame to the GPS receiver 300 within the area. That is, the transmitting unit 260 modulates the GPS-tag frame generated as a baseband signal into a GPS transmission band, and transmits the modulated signal to the GPS receiver 300 within the area.

The control unit 280 is configured to control the function of the GPS transmitter 200 which exchanges information with the additional information providing device 100, generates and transmits the GPS-tag frame, and checks the state of the transmitted signal. That is, the control unit 280 performs the information exchange with the additional information providing device 100 through control of the interface unit 220. The control unit 280 controls the transmitting unit 260 to generate a signal based on the user additional information from the interface unit 220 and the location information from the receiving unit 240. That is, the control unit 280 transmits the received user additional information and location information to the transmitting unit 260. At this time, the control unit 280 transmits the transmit signal generation request signal as well as the user additional information and the location information to the transmitting unit 260. The control unit 280 transmits the transmit signal generation request signal to the transmitting unit 260 and controls the transmitting unit 260 to transmit the generated signal to the GPS receiver 300 within the area. The control unit 280 controls the receiving unit 240 to monitor the transmitted signal and check the state of the transmitted signal.

The GPS receiver 300 detects location information and user additional information from a signal received from the GPS transmitter 200, and provides the detected information to a user. That is, the GPS receiver 300 detects the location information from the GPS-tag frame received from the GPS transmitter 200. The GPS receiver 300 provides a location information providing service (that is, a positioning service), such as a navigation service or map service, to the user using the detected location information. The GPS receiver 300 detects user additional information from the GPS-tag frame received from the GPS transmitter 200. The GPS receiver 300 outputs the detected user additional information, and provides an additional service as well as the location information providing service to the user. For this operation, referring to FIG. 3, the GPS receiver 300 includes a receiving unit 320 and an interface unit 340.

The receiving unit 320 is configured to receive the signal transmitted from the GPS transmitter. That is, the receiving unit 320 receives the transmitted signal configured as a GPS-tag frame in an area where a general GPS signal cannot be received. At this time, the receiving unit 320 receives the GPS-tag frame including the location information and the user additional information. Here, the receiving unit 320 decodes the user additional information included in the GPS-tag frame and transmits the decoded information to the interface unit 340.

The interface unit 340 is configured to provide a navigation service based on the signal received from the receiving unit 320 to the user. That is, the interface unit 340 provides a positioning service such as a navigation service or map service to the user using the location information included in the received signal.

The interface unit 340 provides the user additional information from the receiving unit 320 to the user. That is, the interface unit 340 provides the user additional information to the user through voice and text output.

The interface unit 340 receives setting information for controlling the function of the receiving unit 320 from the user. That is, the interface unit 340 receives the setting information for controlling the function of the receiving unit 320, such as a reception control function for the transmitted signal, from the user. The interface unit 340 provides the received setting information to the control unit 360.

The control unit 360 is configured to control the receiving unit 320 based on the setting information from the interface unit 340. That is, the control unit 360 controls the function of the receiving unit 320, such as the reception control function for the transmitted signal, based on the received setting information.

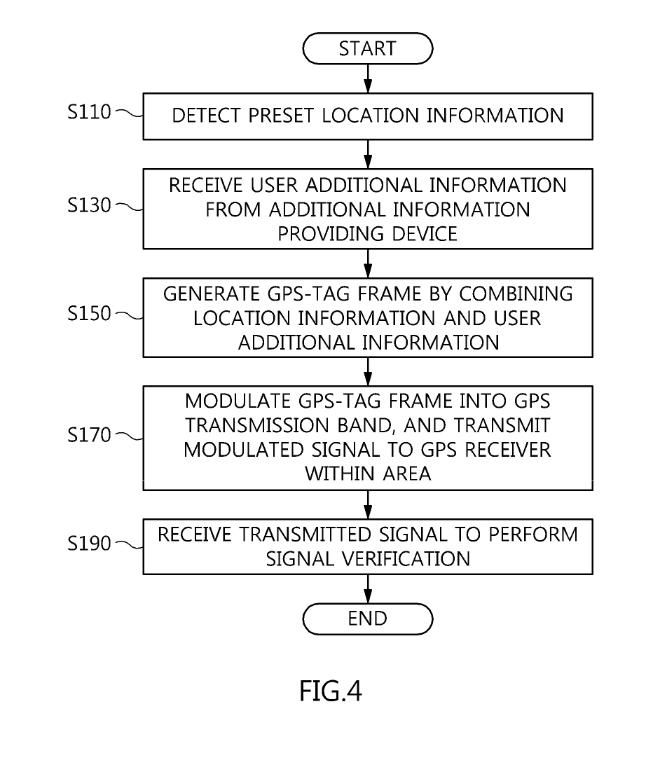

Hereafter, a signal transmission method of the method for providing location information and additional information using a pseudolite navigation system in accordance with the embodiment of the present invention will be described in detail with the accompanying drawings. FIG. 4 is a flow chart showing the signal transmission method of the method for providing location information and additional information using a pseudolite navigation system in accordance with the embodiment of the present invention.

First, the GPS transmitter 200 detects location information at step S110. That is, the GPS transmitter 200 detects preset location information or location information set by a user.

The GPS transmitter 200 receives user additional information from the additional information providing device 100 at step S130. That is, the GPS transmitter 200 transmits a user additional request signal to the additional information providing device 100. The GPS transmitter 200 receives the user additional information based on the request signal from the additional information providing device 100.

The GPS transmitter 200 combines the detected location information and the user additional information and generates a GPS-tag frame at step S150. That is, the GPS transmitter 200 generates the GPS-tag frame by combining the preset location information (or the location information reset by the user) and the received user additional information. At this time, the GPS transmitter 200 generates the GPS-tag frame by combining the user additional information processed in parallel using a plurality of PRN signals. The GPS receiver 200 generates the GPS-tag frame through parallel processing, based on the channel configuration (PRN number) set by the additional information providing device 100. Here, the GPS transmitter 200 generates the baseband GPS-tag frame.

The GPS transmitter 200 modulates the generated GPS-tag frame into a GPS transmission band, and transmits the modulated signal to the GPS receiver 300 within the area at step S170. That is, the GPS transmitter 200 modulates the baseband GPS-tag frame into the GPS transmission band, and transmits the modulated signal to a service area. At this time, the transmitted signal (that is, GPS-tag frame) is received and processed by the GPS receiver 300 entering the service area.

The GPS transmitter 200 receives the transmitted signal and performs signal verification at step S190. That is, the GPS transmitter 200 receives the transmitted signal (that is, the GPS-tag frame), and determines whether the received signal (that is, the GPS-tag frame) is normal or not.

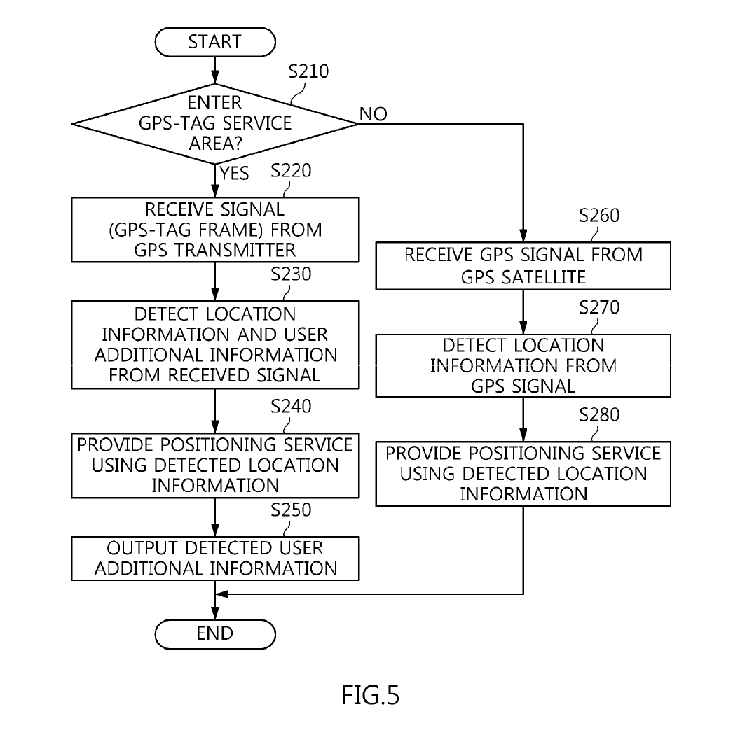

Hereafter, a transmitted signal processing method of the method for providing location information and additional information using a pseudolite navigation system in accordance with the embodiment of the present invention will be described in detail with the accompanying drawings. FIG. 5 is a flow chart showing the transmitted signal processing method of the method for providing location information and additional information using a pseudolite navigation system in accordance with the embodiment of the present invention.

First, when entering the GPS-tag service area at step S210, the GPS receiver 300 receives a signal (GPS-tag frame) transmitted from the GPS transmitter 200 at step S220. That is, when a user enters the GPS-tag service area in a state where the user carries the GPS receiver 300, the GPS receiver 300 receives the signal transmitted from the GPS transmitter 200. At this time, the signal transmitted from the GPS transmitter 200 has the form of a GPS-tag frame including location information and user additional information.

The GPS receiver 300 detects location information and user additional information from the received signal at step S230. That is, the GPS receiver 300 detects the location information and the user additional information from the GPS-tag frame received from the GPS transmitter 200.

The GPS receiver 300 provides a positioning service to the user using the detected location information at step S240. That is, the GPS receiver 300 provides a positioning service such as a navigation service or map service to the user using the detected location information.

The GPS receiver 300 outputs the detected user additional information and provides the outputted information to the user at step S250. That is, the GPS receiver 300 outputs the detected user additional information, and provides an additional service as well as the positioning service to the user.

Here, when getting out of the GPS-tag service area, the GPS receiver 300 receives a GPS signal from a GPS satellite at step S260. That is, when the user gets out of the GPS-tag service area in a state where the user carries the GPS receiver 300, the GPS receiver 300 does not receive a signal transmitted from the GPS receiver 200. Therefore, the GPS receiver 300 receives the GPS signal transmitted from the GPS satellite.

The GPS receiver 300 detects location information from the received GPS signal at step S270, and provides a positioning service to the user using the detected location information at step S280. That is, the GPS receiver detects the location information from the received GPS signal, and provides the positioning service such as a navigation service or map service to the user using the detected location information.

Hereafter, the GPS-tag frame used in the apparatus and method for providing location information and additional information using a pseudolite navigation system in accordance with the embodiment of the present invention will be described in detail with the accompanying drawings.

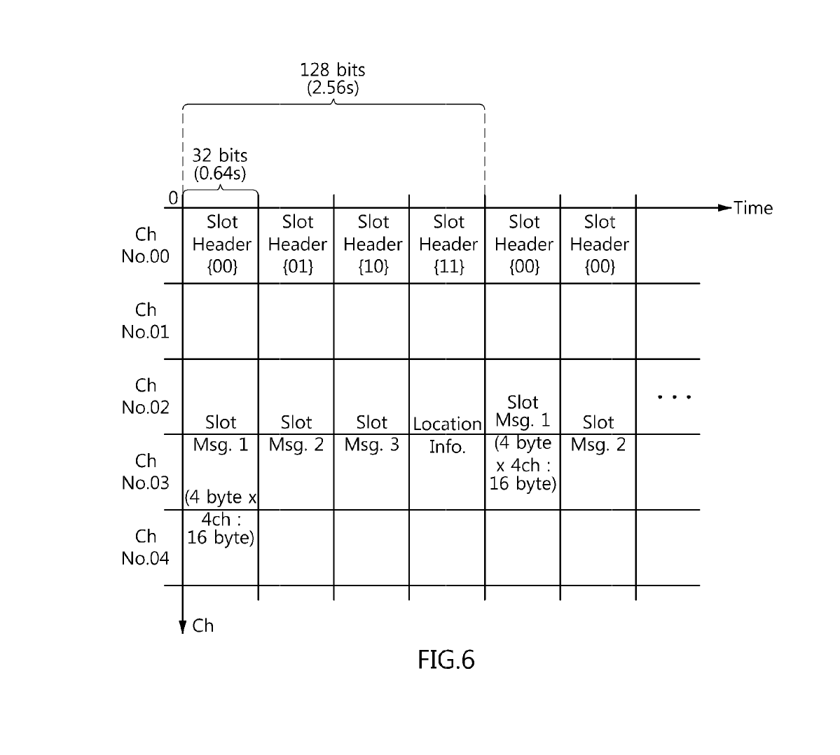

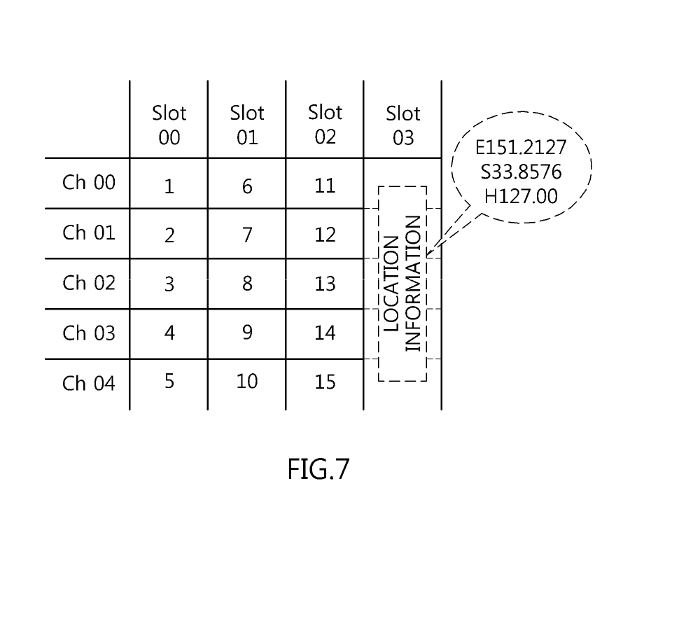

FIG. 6 is a diagram for explaining a data structure of the GPS-tag frame used in the apparatus and method for providing location information and additional information using a pseudolite navigation system in accordance with the embodiment of the present invention. FIG. 7 is a diagram for explaining an example of the GPS-tag frame used in the apparatus and method for providing location information and additional information using a pseudolite navigation system in accordance with the embodiment of the present invention.

The GPS-tag frame includes the same signal as a general GPS signal. In this embodiment of the present invention, the GPS-tag frame is transmitted using PRN codes of GPS L1 C/A, modulated by a binary phase shift keying (BPSK) scheme, and transmitted in a frequency band of 1575.42 MHz which is the same as L1 C/A codes.

The transmitting unit 260 of the GPS transmitter 200 repetitively transmits user additional information during data transmission periods configured as one GPS-tag frame. At this time, the GPS-tag frame includes a plurality of slots corresponding to a number set by a user. The slot is a minimum unit used to transmit the user additional information through the GPS-tag frame.

For example, referring to FIG. 6, the slot of the GPS-tag frame has 32 bits, and it takes 0.64 second to transmit the corresponding slot when the GPS-tag frame is transmitted using the GPS L1 C/A codes.

One GPS-tag frame includes an integer number of slots. At this time, the number of slots forming the GPS-tag frame is set by the user, and transferred to the GPS receiver 300 by a slot header.

When a communication path for transmitting one PRN code is considered as one channel, a plurality of channels may be combined to increase an information transfer ability. That is, a slot head for indicating the configuration and characteristic of the GPS-tag frame and a user-defined message are expressed by combining information divided by 32 bits and expressed as a plurality of PRN codes.

The GPS-tag frame includes four slots, and each of the slots includes one slot header (that is, channel No. 00) and four slot message channels (that is, channel Nos. 01 to 04). At this time, since each of the slot message channels has four bytes, the slot message channels have total 16 bytes (that is, 128 bits). Here, the slot head has 32 bits, and includes slot information and abbreviated user additional information. Since each of the slot message channels has four bytes, the slot message channels may include a 128-bit user-defined message or location information. Whether the corresponding GPS-tag frame provides location information or not is expressed by the slot header. When the GPS-tag frame provides does not provide the location information, a user-defined message having a length of 64 bytes is provided, and when the GPS-tag frame provides the location information, a user-defined message having a length of 48 bytes and location information set in the GPS-tag frame by the user are provided using a final slot of the GPS-tag frame.

For example, suppose that data to be indicated by one channel during one slot is one number, and the GPS transmitter transmits the data through five channels. At this time, the GPS transmitter provides a user message (“1 2 3 4 5 6 7 8 9 10 11 12 13 14 15”) and location information (E151.2127, S33.8575, and H127.00).

In this case, the GPS receiver generates a GPS-tag frame illustrated in FIG. 7. The GPS transmitter sets a slot header according to a user's setting.

The GPS receiver displays a message of “1 2 3 4 5” as PRN codes corresponding to five channels of a slot Slot00 through the channels, and then combines the PRN codes (1+2+3+4+5). Then, the GPS transmitter modulates the combined signal into a GPS transmission-band signal, and transmits the modulated signal to the GPS receiver. The GPS receiver decodes the received GPS-tag frame into PRN cods corresponding to the respective channel signals, decrypts the messages indicated by the respective channels, and forms the message of “1 2 3 4 5”.

Then, the GPS transmitter displays the above-described PRN codes for slots Slot01 and Slot02 and modulates the PRN codes into a transmission-band signal, and the GPS receiver decodes the modulated signal and forms a user message.

The GPS receiver transmits location information E151.2127, S33.8576, and H127.00 through five channels of the slot Slot03. The GPS receiver converts location information included in the slot Slot03 according to the NMEA (National Marine Electronics Association) standard, and provides the converted location information to a user or service platform.

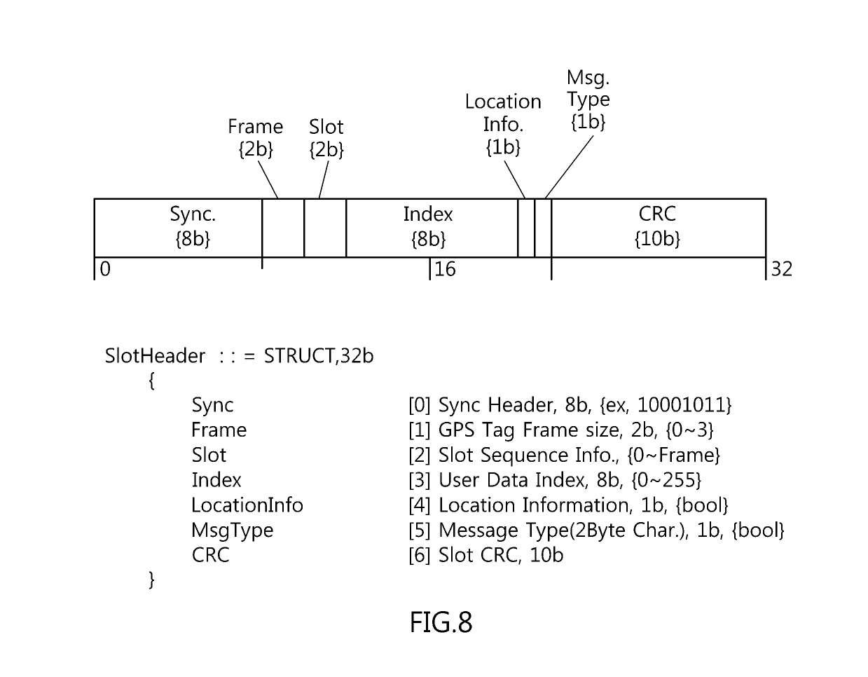

FIG. 8 is a diagram for explaining the structure of the slot head of FIG. 6.

Referring to FIG. 8, the slot header has a length of 32 bits (0.64 second), and includes a field for synchronizing the entire channels, a field for indicating the length of a GPS-tag frame, a field for indicating the index of a slot which is currently transmitted, a field for a codebook index for indicating abbreviated user information, a field for indicating whether location information is provided or not, a field for indicating the data type of a message field, and a field for indicating additional information.

The slot header indicated in the ASN. 1 type includes a sync field, a frame field, a slot field, an index field, a location information field, a message type field, and a cyclic redundancy check (CRC) field.

The sync field is used to estimate synchronization for a corresponding slot in a data column transmitted by combining a plurality of RPN codes. For this operation, the sync field has eight bits.

The frame field is used to estimate the size of the GPS-tag frame. For this operation, the frame field has two bits. That is, the frame field is information indicating which slots the GPS-tag frame includes. For example, when the GPS-tag frame includes four slots, the value of the frame field becomes 11 b (3). The user may recognize that the GPS-tag frame includes four slots through the value of the frame field.

The slot field indicates the position of a current slot in the entire slots set by the GPS-tag frame. That is, the slot field indicates the sequence of the current slot in the entire slots of the GPS-tag frame. For example, when the value of the slot field is 00b, the current slot indicates a first slot among the entire slots, and when the value of the slot field is 10b, the current slot indicates a third slot among the entire slots. For this operation, the slot field has two bits.

The index field is used to estimate a user data index. For this operation, the index field has eight bits. That is, the index field is used to designate an expression order of user information using the range of the index field, when the abbreviated user information is expressed through the slot head. For example, suppose that 0 to 127 (first area) of the index field are set to a forward direction, and 128 to 255 (second area) are set to a reverse direction. When “Big Chance!!!” is set in 000 of the index field and the message information is “Today”, a final sentence is expressed as “Big Chance!!! Today”. When “Big Chance!!!” is set in 128 of the index field and the message information is “Today”, a final sentence is expressed as “Today Big Chance!!!”.

The location information field is used to control the transmission of location information, when the location information set by a service provider exists in the corresponding GPS-tag frame and is provided to the user. For this operation, the location information field has one bit.

The message type field is used to indicate the type of data transmitted through a slot message. That is, the message type field is used to discriminate a case in which the provided information includes two-byte codes like Unicode from a case in which the provided information includes one-byte codes composed of only English characters or numbers. For this operation, the message type field has one bit.

The CRC field is used to determine whether an error occurred in the GPS-type frame. For this operation, the CRC field has ten bits.

Through the above-described fields, it is possible to maximize transmission efficiency of the service information. The additional information field may be used by allocating an error correction code for detecting and correcting an error in the expression sequence between the abbreviated user information provided by the slot header and the message information provided through the slot message.

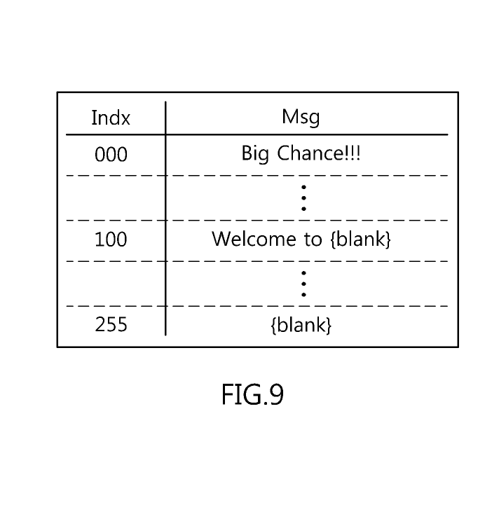

FIG. 9 is a diagram for explaining a use example of the index field of FIG. 8.

An index value of a codebook for utilizing the abbreviated user information using the user data index field is indicated by the value of the corresponding field of the slot header. That is, a usable codebook is previously defined, and index values corresponding to a message which is to be provided by the service provider are discriminated for the respective slots and set in the GPS-tag frame. Then, the corresponding index values are sequentially transmitted according to the slot sequence.

Meanwhile, the corresponding codebook is provided when a service solution for providing additional information related to the GPS receiver 300 is reset or information on the corresponding solution is updated. When the user enters the service area such that the GPS receiver 300 receives a signal transmitted from the GPS transmitter 200 and extracts a user data index field inserted into a slot header, a preset sentence corresponding to the index is extracted and displayed on the GPS receiver 300 (that is, user terminal) according to a transfer sequence related to additional information. The additional information using the slot header may be combined with user-defined information (that is, user additional information) transferred through the slot message, in order to transfer a user message.

The process of providing location information through the slot header will be described as follows. Whether or not to provide location information is controlled by the location information field of the slot header. When the location information field is set to provide the location information, location information inputted to the GPS-tag frame by the user is provided in the form of raw data having a 128-bit numerical value. The corresponding location information is provided by the final slot of the GPS-tag frame, and longitude and latitude information received in the form of raw data is converted into NMEA standard information by a GPS-tag service solution in the user side and then transferred to an application program.

Furthermore, the information provided through the slot message may include URL link information configured in a shortened URL type. The URL link information determines whether the data form of the slot message is a two-byte type or one-byte type, through the message type field of the slot header, such that a limited information transfer capacity may be efficiently used. Through the URL link service, the service provider may directly move to an URL in which the user has interest, or the user terminal may directly receive information such as pamphlet information.

As described above, the apparatus and method for providing location information and additional information using a pseudolite navigation system in accordance with the embodiment of the present invention has the following effect: when a user using the location information and user-defined additional providing service through a GPS-tag enters an indoor service area using a GPS-tag in a state where the user carries a terminal having a GPS-tag information receiving function, the apparatus and method continuously provides location information using a GPS receiver which cannot be used indoors in the case of the conventional system, and provides user additional information set in the GPS-tag system, thereby increasing the service utilization degree.

While the present invention has been described with respect to the specific embodiments, it will be apparent to those skilled in the art that various changes and modifications may be made without departing from the spirit and scope of the invention as defined in the following claims.

What is claimed is:

1. A global positioning system (GPS) transmitter comprising:
an interface unit configured to receive user additional information from an additional information providing device;
a location information providing unit configured to manage preset location information or location information set by a user; and
a transmitting unit configured to generate a GPS-tag frame by combining the user additional information and the location information from the location information providing unit based on a plurality of pseudo random noise (PRN) codes, and transmit the generated GPS-tag frame to a service area.

2. The GPS transmitter of claim 1, wherein the transmitting unit generates the GPS-tag frame having a plurality of slots matched with the respective PRN codes, and each of the slots comprises a slot header and a slot message.

3. The GPS transmitter of claim 2, wherein the slot header comprises an index field for setting a GPS-tag solution and recording an index of an additional information table, in order to transmit the user additional information.

4. The GPS transmitter of claim 3, wherein the index field is classified into two areas, a message arranged in the front portion of user information is set in the first area, and a message arranged in the rear portion of the user information is set in the second area.

5. The GPS transmitter of claim 2, wherein the slot header comprises a slot field for recording slot information forming the GPS-tag frame, and an information transfer period is set based on the number of slots included in the slot information.

6. The GPS transmitter of claim 2, wherein the slot header comprises a location information field for recording whether location information is provided or not.

7. The GPS transmitter of claim 6, wherein, when the location information field indicates that the location information is provided, the location information is recorded in the final slot among the plurality of slots.

8. The GPS transmitter of claim 2, wherein the slot header comprises a message type field for recording the type of data recorded in the slot message.

9. The GPS transmitter of claim 2, wherein the slot message comprises link information corresponding to a reception path of additional information.

10. The GPS transmitter of claim 1, wherein the slot header comprises a cyclic redundancy check (CRC) field to record an error correction code for expressing an expression sequence between abbreviated user information provided through the slot header and message information provided through a slot message, and detecting and correcting an error.

11. A method for providing location information and additional information using a pseudolite navigation system, comprising:
receiving user additional information from an additional information providing device by a GPS transmitter;
detecting preset location information by the GPS transmitter;
generating a GPS-tag frame by combining the user additional information and the detected location information based on a plurality of PRN codes by the GPS transmitter; and
transmitting the generated GPS-tag frame to a service area by the GPS transmitter.

12. The method of claim 11, wherein, in the generating the GPS-tag frame, generating the GPS-tag frame having a plurality of slots matched with the respective PRN codes by the GPS transmitter, and each of the slots comprises a slot header and a slot message.

13. The method of claim 12, wherein, in the generating the GPS-tag frame,
generating the GPS-tag frame comprising a slot header having an index field for setting a GPS-tag solution and recording an index of an additional information table, in order to transmit the user additional information by the GPS transmitter.

14. The method of claim 13, wherein, in the generating the GPS-tag frame, classifying the index field as two areas, a message arranged in the front portion of user information is set in the first area, and a message arranged in the rear portion of the user information is set in the second area.

15. The method of claim 12, wherein, in the generating the GPS-tag frame,
generating the GPS-tag frame comprising a slot header having a slot field for recording slot information forming the GPS-tag frame by the GPS transmitter, and
an information transfer period is set based on the number of slots included in the slot information.

16. The method of claim 12, wherein, in the generating the GPS-tag frame, generating the GSP-tag frame comprising a slot header having a location information field for recording whether the location information is provided or not by the GPS transmitter.

17. The method of claim 16, wherein, in the generating the GPS-tag frame,
when the location information field indicates that the location information is provided, the location information is recorded in the final slot among the plurality of slots.

18. The method of claim 12, wherein, in the generating the GPS-tag frame,
generating the GPS-tag frame comprising a slot header having a message type field for recording the type of data recorded in the slot message by the GPS transmitter.

19. The method of claim 12, wherein, in the generating the GPS-tag frame,
generating the GPS-tag frame comprising a slot message having link information corresponding to a reception path of additional information by the GPS transmitter.

20. The method of claim 12, wherein, in the generating the GPS-tag frame,
generating the GPS-tag frame comprising a slot header having a CRC field to record an error correction code for expressing an expression sequence between abbreviated user information provided through the slot header and message information provided through a slot message, and detecting and correcting an error.
